(19) United States
(12) Patent Application Publication
(10) Pub. No.: US 2017/0065895 A1
(43) Pub. Date: Mar. 9, 2017

(54) PIXEDUP SOCIAL MEDIA GAME

(71) Applicants: Joseph FELIX, San Diego, CA (US); Olin TICHY, San Diego, CA (US)

(72) Inventors: Joseph FELIX, San Diego, CA (US); Olin TICHY, San Diego, CA (US)

(21) Appl. No.: 14/849,007

(22) Filed: Sep. 9, 2015

(51) Int. Cl. A63F 13/822; A63F 9/24; A63F 13/44

(52) U.S. Cl. CPC A63F 13/822; A63F 13/44; A63F 9/24; A63F 2009/246

(57) ABSTRACT

A social media game that may be played between two devices, or as a single device may be played on an electronic mobile device such as a smart phone or tablet. The game may be analogous to a photographic puzzle. The device may perform a set of operations such that a photograph is substantially altered into a multimedia puzzle. Any photograph or image may be used. Additionally the device may communicate with an elaborate electronic social media network consisting of any number of devices and automated systems. Devices may display unique messages to one another which may display prior to or upon completion of an operation on a display screen. If a device successfully completes multimedia puzzle electronic social media network may record the time and display it to any number of additional devices.

### BACKGROUND

Social Media Games may be played between users over an online social network with a mobile phone or smart mobile device. These games may be played by multiple users competitively against one another or these games may be played individually, at large, against the online community or portions of it. Additionally, these games may be played collaboratively. These games may consist of puzzles that users may solve to unlock additional messages, levels, prizes, or for the thrill of the game.

### SUMMARY

According to an exemplary embodiment, an interactive social media game may be played on an electronic social media network with any number of unique users, players, or devices. A first device may create a disassembled photographic media puzzle through manipulation on a display screen, in a first memory location and transmit a request to share a disassembled photographic media puzzle by a transceiver. A second device may receive the disassembled photographic media puzzle by a transceiver and store it in a second memory location. The second device may re-assemble the disassembled photographic media puzzle through manipulation on a display screen into a re-assembled photographic media puzzle. The re-assembled photographic media puzzle may be automatically verified for correctness against a solution on a puzzle piece by puzzle piece basis.

According to another exemplary embodiment, an interactive social media game may consist of at least one device and a computer database. The computer database may transmit a disassembled photographic media puzzle by a transceiver. The at least one device may receive the disassembled photographic media puzzle by a transceiver. The at least one device may store the disassembled photographic media puzzle in a memory location. The at least one device may re-assemble, through manipulation on a display screen, the disassembled photographic media puzzle into a re-assembled photographic media puzzle. The re-assembled photographic media puzzle may be automatically verified for correctness against a solution on a puzzle piece by puzzle piece basis.

According to another exemplary embodiment, a computing system may execute a set of instructions for an interactive social media game. The computing system may take an electronic photograph by an electronic photography device and lens and store the electronic photograph in a first memory location. A device may manipulate a disassembled photographic media puzzle on a display interface. The device may create a disassembled photographic media puzzle through manipulation on a first display interface and store it in a first memory location. The device may transmit the disassembled photographic media puzzle by a transceiver. A second device may receive the disassembled photographic media puzzle by a transceiver and store the disassembled photographic media puzzle in a second memory location. The second device may re-assemble the disassembled photographic media puzzle into a re-assembled photographic media puzzle through manipulation on a second display interface. The re-assembled photographic media puzzle may be automatically verified for correctness against a solution on a puzzle piece by puzzle piece basis.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

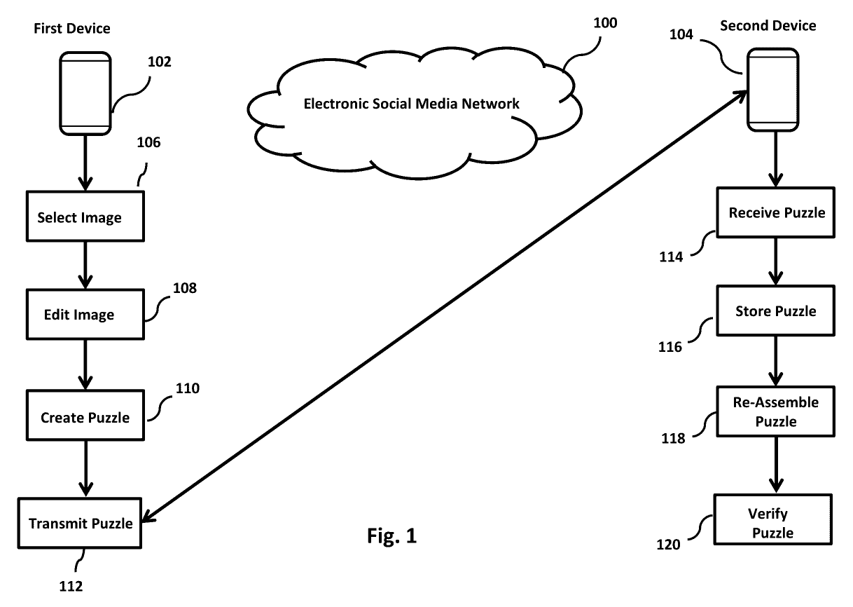

Exemplary FIG. 1 may show an exemplary flow chart of an electronic social media network or game;

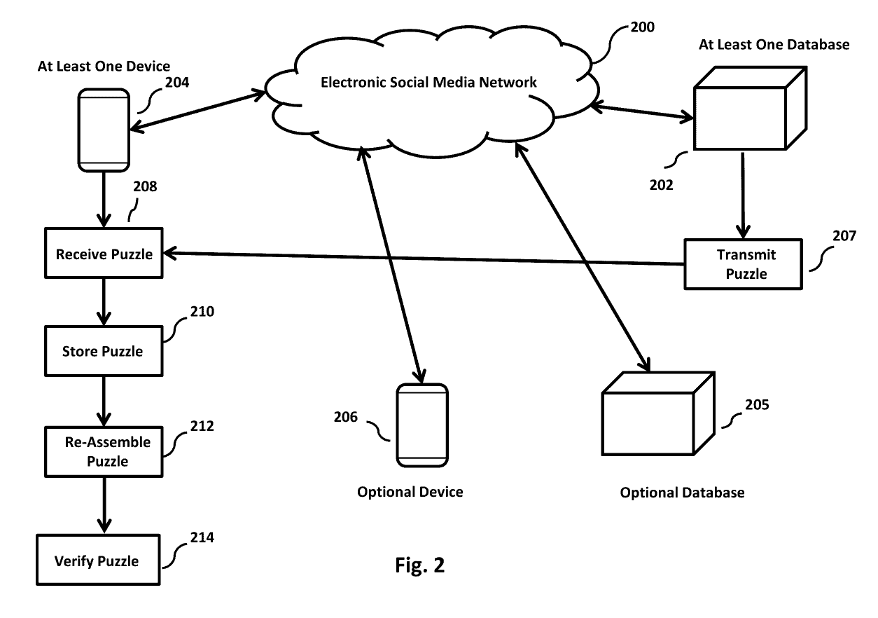

Exemplary FIG. 2 may show an exemplary flow chart of an electronic social media network or game;

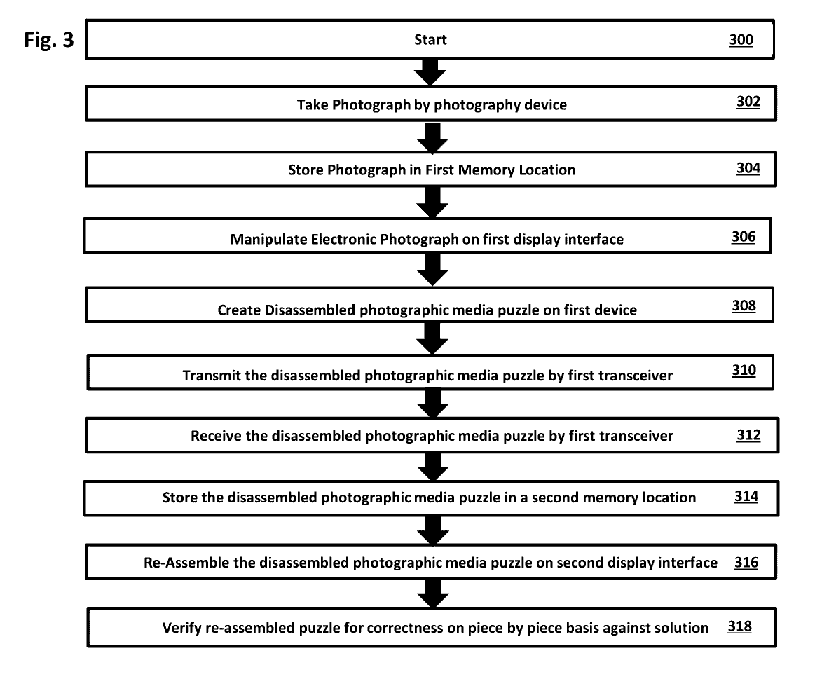

Exemplary FIG. 3 may show a flow chart of the steps a non-transitory computer readable medium of an electronic social media network or game may implement;

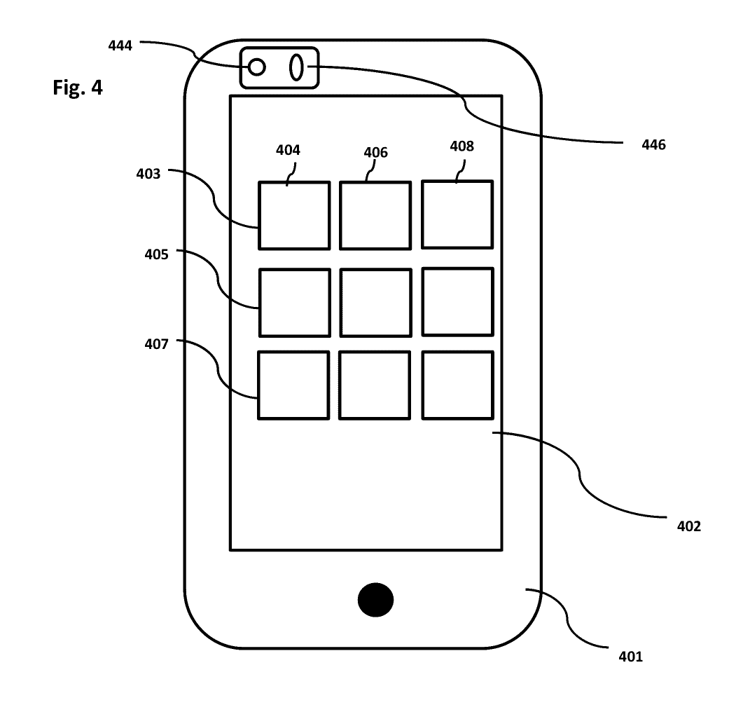

Exemplary FIG. 4 may show a depiction of a disassembled photographic media puzzle;

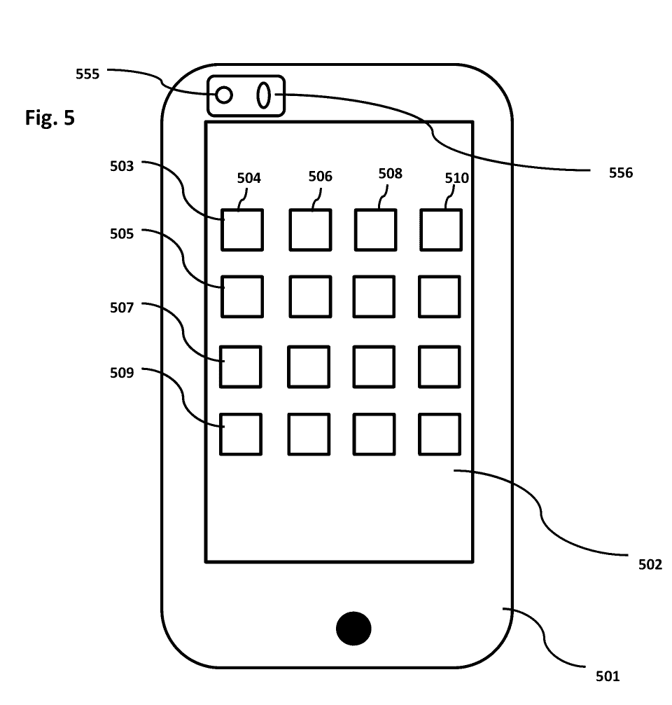

Exemplary FIG. 5 may show an alternate depiction of a disassembled photographic media puzzle;

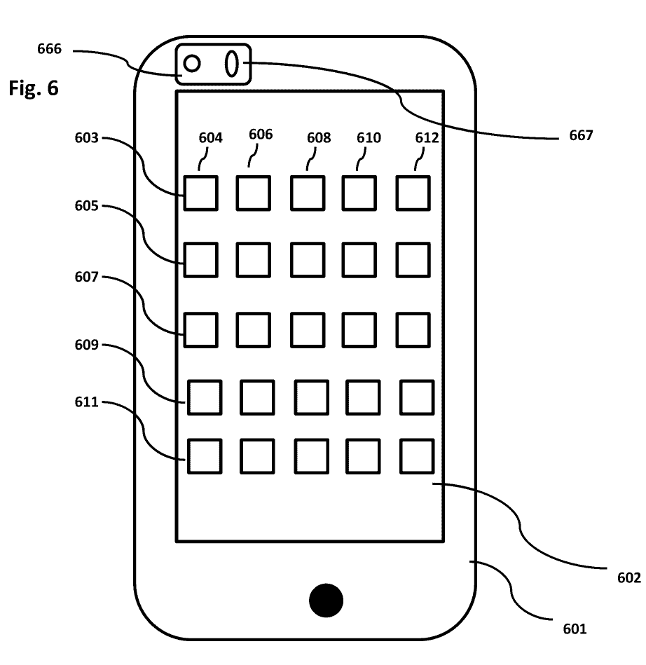

Exemplary FIG. 6 may show an alternate depiction of a disassembled photographic media puzzle;

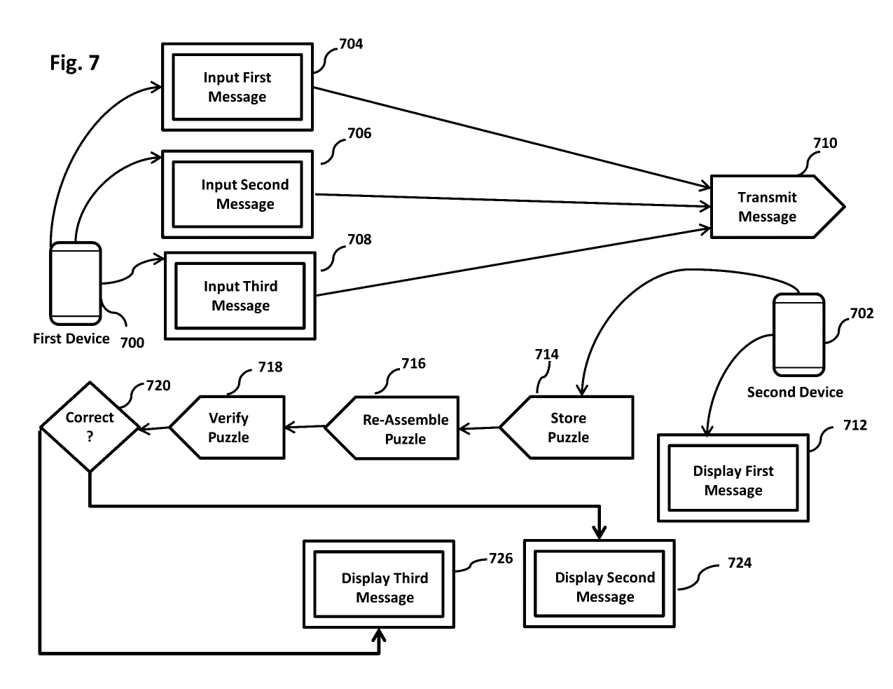

Exemplary FIG. 7 may show the steps of a message system of an electronic social media network or game; and

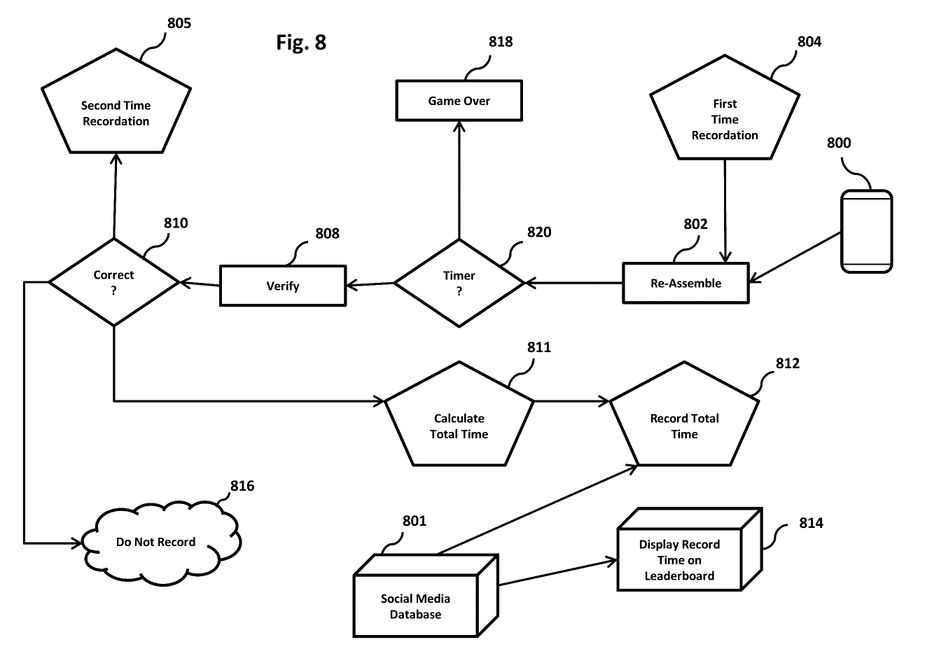

Exemplary FIG. 8 may show the steps of a time recordation system of an electronic social media network or game.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

Referring to FIG. 1 generally, a photographic media puzzle game played on an electronic social media network may be disclosed. The electronic social media network or game may consist of multiple devices using non-transitory computer readable mediums, such as a smart phone, tablet, or other similarly situated device to play a photographic media puzzle game. The photographic media puzzle game may consist of a first device 102, a second device, 104 and an electronic social media network 100. The first device 102 may operate a first non-transitory computer readable medium. The second device 104 may operate a second non transitory computer readable medium. A first device 102 may select 106 an image. The image may be a photograph taken by an electronic smart phone, tablet, or other similarly situated device that can take a photograph. The image may also be a stock image that the device may have downloaded to an electronic smart phone, tablet, or other similarly situated device. Next, the first device 102 may edit 108 the image. The step of editing 108 the image may be any type of image editing options common to electronic smart phones, tablets, and other similarly situated devices known in the art such as applying a filter. Next, the device may create 110 a disassembled photographic media puzzle. The device may create 110 the disassembled photographic media puzzle through manipulation on a display interface such as a touch screen. For example, the device may partition the image into unique puzzle pieces by finger swiping across a display interface. Alternatively, the device may partition the image into unique puzzle pieces automatically. Alternatively, the device may allow a user to manually manipulate the location, size, and type of puzzle piece. The disassembled photographic media puzzle may be stored in a first memory location. The disassembled photographic media puzzle may be an edited 108 image or it may be the original selected 106 image. The disassembled photographic media puzzle may be a matrix of any number of uniform pieces. The disassembled photographic media puzzle may be a plurality of any number of non-uniform pieces. The device may transmit 112 the disassembled photographic media puzzle by a transceiver to a second device. The transceiver may be a local area network, cell phone signal, wireless signal, or any other hardware element capable of transmitting data elements from a first memory location to a second memory location. The disassembled photographic media puzzle may be transmitted 112 across the electronic social media network to a second device 104. The second device 104 may be a native contact of the first device 102 that may store the second devices 104 information in the contacts menu of an electronic smart phone, tablet, or any other similarly situated device known in the art. The second device 104 may receive 114 the disassembled photographic media puzzle that a first device 102 transmit 112. Next, the second device 104 may store 116 the disassembled photographic media puzzle in a second memory location. Next, the second device may re-assemble 118 the disassembled photographic media puzzle into a re-assembled photographic media puzzle. The re-assembled photographic media puzzle may be verified 120 automatically on a puzzle piece by puzzle piece basis for correctness against a solution. The re-assembled photographic media puzzle may be verified 120 by displaying the re-assembled photographic media puzzle on the first device thereby allowing the first device to verify 120 the re-assembled photographic media puzzle manually. The disassembled photographic media puzzle may be automatically verified 120 for correctness against a solution on a puzzle piece by puzzle piece basis. The electronic social media network may verify the puzzle against a database of solutions. The solution may be established by the first device 102. The solution may originate on the electronic social media network or the solution may be established by the first device 102.

Referring to FIG. 2 generally, a photographic media puzzle game on an electronic social media network may be disclosed. An at least one device 204 may be in communication with an electronic social media network 200. The electronic social media network 200 may be in communication with an at least one non-transitory computer database 202. The at least one non-transitory computer database 202 may physically store data elements of the electronic social media network. The at least one non-transitory computer database 202 may transmit 207 a disassembled photographic media puzzle by a transceiver. Any number of optional additional devices 206 and optional computer databases 205 may be in communication with an electronic social media network 200. The at least one device 204 may be in communication with an electronic social media network 200 such that the at least one device 204 may receive 208 a puzzle by a transceiver. The at least one device 204 may chose a disassembled photographic media puzzle based on a category, sub-category, or group of interest. Additionally, the at least one device 204 may choose the difficulty of the puzzle. The difficulty may correspond to the number of unique pieces that make up the disassembled photographic media puzzle. The puzzle may have been previously disassembled by the electronic social media network or an optional additional device 206 or an optional database 205. Alternatively the disassembled photographic media puzzle may have originated from any unique location such that it may be reducible to a stored location on the electronic social media network. The at least one device 204 may re-assemble 212 the puzzle. The at least one device 204 may move pieces of the puzzle into a location by manually dragging the pieces of the puzzle into the desired virtual location on a display interface such as a touch screen. The at least one device 204 may move pieces of the puzzle through any desired form of manipulation commonly known in the art of computer, tablet, and electronic smart phone interaction. The re-assembled photographic media puzzle may be verified 214 automatically on a puzzle piece by puzzle piece basis for correctness against a solution. The disassembled photographic media puzzle may be automatically verified 214 for correctness against a solution on a puzzle piece by puzzle piece basis. The electronic social media network may verify the puzzle against a database of solutions that may be stored on the computer database.

Referring to FIG. 3, a set of instructions to play a photographic media puzzle game may be disclosed. The set of instructions may be stored and carried out by a first non-transitory computer readable medium and a second non transitory computer readable medium or any number of additional non transitory computer readable mediums. The non-transitory computer readable mediums may be a smart mobile device, smart phone, tablet, or other similarly situated device known in the art. Additionally, the set of instructions may begin or resume at any unique step. The set of instructions may be limited to a single actor or multiple actors. The set of instructions may begin with starting 300. A first device may take a photograph 302 with a camera lens. The first device may store 304 a photograph in a first memory location. The first device may manipulate 306 the electronic photograph on a first display interface. The first device may apply any filter or perform any photo manipulation or editing that may commonly be known within the art of electronic photography. Next, the first device may create 308 a disassembled photographic media puzzle on a first device. The disassembled photographic media puzzle may be created from a photograph, image, or other manipulated image or photograph. The disassembled photographic media puzzle may be a matrix of any number of uniform pieces. The disassembled photographic media puzzle may be a plurality of any number of non-uniform pieces. Next, the first device may transmit 310 the disassembled photographic media puzzle to a second non-transitory computer readable medium by a transceiver. The second device may receive 312 the disassembled photographic media puzzle. The second device may store 314 the disassembled photographic media puzzle. The second device may re-assemble 316 the disassembled photographic media puzzle. Finally, the disassembled photographic media puzzle may be automatically verified 318 for correctness against a solution on a puzzle piece by puzzle piece basis, where each of the puzzle pieces of the re-assembled photographic media puzzle is compared to the corresponding position of a solution for correctness. The electronic social media network may verify the puzzle against a database of solutions.

Referring generally to FIG. 4, an exemplary embodiment of a disassembled photographic media puzzle may be disclosed. A device 401 may be an electronic smart phone, tablet, or any other similarly situated device known in the art. The device 401 may have a display screen 402, an electronic camera 444, and an electronic flash system 446. The device may take a photograph with the electronic camera 444. The electronic flash system 446 may or may not be used. The photograph may be used as the basis for creating a disassembled photographic media puzzle. Optionally, the image used to create the disassembled photographic media puzzle may be downloaded from a database or a stock photo stored on the device. A solution may be created by storing the initial presentation of the puzzle pieces. The solution may later be used as the basis for comparison and verification of the re-assembled photographic media puzzle. Groups of rectangular cells 403 through 408 may be displayed by the display screen 402. The groups of rectangular cells 403 through 408 may represent a disassembled photographic media puzzle. The disassembled photographic media puzzle may consist of a first row of three cells 403, a second row of three cells 405, and a third row of three cells 407. The disassembled photographic media puzzle may consist of a first column of three cells 404, a second column of three cells 406, and a third column of three cells 408. The three rows of three cells 403, 405 and 407 respectively in combination with the three columns of three cells 404, 406, and 408 respectively may be arranged such that a total of nine cells may represent a disassembled photographic media puzzle.

Referring generally to FIG. 5, an exemplary embodiment of a disassembled photographic media puzzle may be disclosed. A device 501 may be an electronic smart phone, tablet, or any other similarly situated device known in the art. The device 501 may have a display screen 502, an electronic camera 555, and an electronic flash system 556. The device 501 may take a photograph with the electronic camera 555. Additionally the electronic flash system 556 may or may not be used. The photograph may be used as the basis for creating a disassembled photographic media puzzle. Optionally, the image used to create the disassembled photographic media puzzle may be downloaded from a database or a stock photo stored on the device. A solution may be created by storing the initial presentation of the puzzle pieces. The solution may later be used as the basis for comparison and verification of the re-assembled photographic media puzzle. Groups of rectangular cells 503 through 510 may be displayed by the display screen 502. The groups of rectangular cells 503 through 510 may represent a disassembled photographic media puzzle. The disassembled photographic media puzzle may consist of a first row of four cells 503, a second row of four cells 505, a third row of four cells 507, and a fourth row of four cells 509. The disassembled photographic media puzzle may consist of a first column of four cells 504, a second column of four cells 506, a third column of four cells 508, and a fourth column of four cells 510. The four rows of four cells 503, 505, 507, and 509 respectively and in combination with the four columns of four cells 504, 506, 508, and 510 respectively may be arranged such that a total of sixteen cells may represent a disassembled photographic media puzzle.

Referring generally to FIG. 6, an exemplary embodiment of a disassembled photographic media puzzle may be disclosed. A device 601 may be an electronic smart phone, tablet, or any other similarly situated device known in the art. The device 601 may have a display screen 602, an electronic camera 666, and an electronic flash system 667. The device 601 may take a photograph with the electronic camera 666. Additionally, the electronic flash system 667 may or may not be used. The photograph may be used as the basis for creating a disassembled photographic media puzzle. Optionally, the image used to create the disassembled photographic media puzzle may be downloaded from a database or a stock photo stored on the device. A solution may be created by storing the initial presentation of the puzzle pieces. The solution may later be used as the basis for comparison and verification of the re-assembled photographic media puzzle. Groups of rectangular cells 603 through 612 may be displayed by the display screen 602. The groups of rectangular cells 603 through 612 may represent a disassembled photographic media puzzle. The disassembled photographic media puzzle may consist of a first row of five cells 603, a second row of five cells 605, a third row of five cells 607, a fourth row of five cells 609 and a fifth row of five cells 611. The disassembled photographic media puzzle may consist of a first column of five cells 604, a second column of five cells 606, a third column of five cells 608, a fourth column of five cells 610, and a fifth column of five cells 612. The five rows of five cells 603, 605, 607, 609 and 611 respectively and in combination with the five columns of five cells 604, 606, 608, 610, and 612 respectively may be arranged such that a total of twenty five cells may represent a disassembled photographic media puzzle.

Referring generally to FIG. 7, an exemplary embodiment of a photographic media puzzle and a corresponding messaging method of an electronic social media network may be disclosed. A first device 700 may input a first message 704 and transmit the message 710 to a second device 702 by a transceiver. The second device 702 may store 714 the first message 704. The second device 702 may display the message 712. The second device 702 may display the message on the display screen of any device such as an electronic smart phone, tablet, or any other similarly situated device known in the art. The first message 704 may display prior to the second devices 702 attempt to re-assemble the puzzle 716. Alternatively, the first message may be intended as an invitation to join the electronic social media network. A first device 700 may input a second message 706 and a third message 708. The first device 700 may transmit 710 the messages to a second device 702. The second device 702 may be a native contact of the first device 700 who may store the second devices 702 information in the contacts menu of an electronic smart phone, tablet, or any other similarly situated device known in the art. The second device 702 may store 714 the second message 706 and the third message 708. The second device 702 may re-assemble the puzzle 716. The disassembled photographic media puzzle may be automatically verified 718 for correctness against a solution on a puzzle piece by puzzle piece basis, each of the puzzle pieces of the re-assembled photographic media puzzle may be compared to the corresponding position of a solution for correctness. The electronic social media network may verify the puzzle against a database of solutions. Correct conditional operator 720 may be a yes/no conditional operation. The yes/no correct conditional operator 720 may be an additional step that may be dependent upon the verify puzzle 718 step. If the puzzle is verified as correct against a pre-determined solution a second message 724 may be displayed. If the message is not verified as correct a third message 726 may be displayed. The first 704, second 706, and third 708 messages may be multimedia messages that may contain data elements that may be used to play sound and movies. The first 704, second 706, and third 708 messages may be multimedia messages that may contain the solution to a disassembled photographic media puzzle. The first 704, second 706, and third 708 messages may be hyperlinks to e-commerce websites that may reward a user for playing the social media game. The first 704, second 706, and third 708 messages may be hyperlinks to send an SMS message to an original device or a new device. The first 704, second 706, and third 708 messages may be hyperlinks to any type of external computer implemented program, website, blog, or digital platform.

Referring generally to FIG. 8, an exemplary embodiment of a photographic media puzzle and a corresponding time recordation system may be disclosed. A device 800 may re-assemble 802 a disassembled photographic media puzzle, which may initiate a first time recordation 804. After re-assembling the disassembled photographic media puzzle a verify 808 step may be performed. The disassembled photographic media puzzle may be automatically verified 808 for correctness against a solution on a puzzle piece by puzzle piece basis, each of the puzzle pieces of the re-assembled photographic media puzzle may be compared to the corresponding position of a solution for correctness. The electronic social media network may verify the puzzle against a database of solutions. Correct conditional operator 810 may be a yes/no conditional operation. The correct conditional operator 810 may be an additional step that may be dependent upon the verify puzzle 808 step. If the puzzle is verified as correct against a pre-determined solution a second time recordation 805 may occur. Additionally, if the puzzle is verified as correct against a pre-determined solution a calculate total time 811 step may be performed. The calculate total time 811 step may calculate the total time by determining the difference between the first time recordation 804 and the second time recordation 805. The time may be recorded in any time display format commonly known in the art. Additionally, the time may be recorded 812 and displayed 814 on a social media network database 801. The method of display may be a leaderboard or other method to display player statistics. The leaderboard may be organized by puzzle, category, or sub category. If the correct conditional operator 810 is not correct than the system may not calculate the total time 811 and may not record the total time 812. Optionally, throughout the duration of playing the photographic media puzzle a timer conditional operator 820 may keep track of the total time a device has been re-assembling the disassembled photographic media puzzle. Timer conditional operator 820 may be a yes/no conditional operator. The timer conditional operator 820 may be an additional step that may be dependent upon a pre-determined device input. The timer conditional operator 820 may be configured for any range of time. The timer conditional operator 820 may be configured by a first device or by the social media network database. If the timer conditional operator 820 is not exceeded than the timer will do nothing. If the timer conditional operator 820 is exceeded than the game may end.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer implemented method for operating a photographic media puzzle game on an electronic social media network of at least a first non-transitory computer readable medium and a second non-transitory computer readable medium comprising:
creating, by at least one computer processor through manipulation on a first display interface, a disassembled photographic media puzzle by a first non-transitory computer readable medium in a first memory location transmitting, by at least one transceiver, the disassembled photographic media puzzle by the first non-transitory computer readable medium;
receiving, by at least one transceiver, the disassembled photographic media puzzle by a second non-transitory computer readable medium;
storing, by at least one computer processor, the disassembled photographic media puzzle by the second non-transitory computer readable medium in a second memory location;
re-assembling, by at least one computer processor through manipulation on a second display interface, the disassembled photographic media puzzle into a re-assembled photographic media puzzle by the second non-transitory computer readable medium; and
verifying automatically, by at least one computer processor on a puzzle piece by puzzle piece basis, each of the puzzle pieces of the re-assembled photographic media puzzle to the corresponding position of a solution for correctness.

2. The method of claim 1, further comprising applying a computer implemented photographic filter to an electronic image used to create the disassembled photographic media puzzle by the first non-transitory computer readable medium.

3. The method of claim 1, further comprising portioning the disassembled photographic media puzzle into a matrix of uniform pieces by the first non-transitory computer readable medium.

4. The method of claim 1, further comprising portioning the disassembled photographic media puzzle into a plurality of non-uniform pieces by the first non-transitory computer readable medium.

5. The method of claim 1, further comprising transmitting a first electronic message, by at least one transceiver, to the second non-transitory computer readable medium that is visible prior to the re-assembling of the disassembled photographic media puzzle from the first non-transitory computer readable medium.

6. The method of claim 1, further comprising transmitting a second electronic message, by at least one transceiver, to the second non-transitory computer readable medium that is visible if the re-assembled photographic media puzzle is not verified as correct against the solution from the first non-transitory computer readable medium.

7. The method of claim 1, further comprising transmitting a second electronic message, by at least one transceiver, to the second non-transitory computer readable medium that is visible if the re-assembled photographic media puzzle is verified as correct against the solution from the first non-transitory computer readable medium.

8. The method of claim 1, further comprising transmitting the solution with an accompanying set of instructions to display the solution for a limited amount of time prior to commencing the re-assembling of the disassembled photographic media puzzle, by at least one transceiver, to the second non-transitory computer readable medium from the first non-transitory computer readable medium.

9. The method of claim 1, further comprising transmitting an invitation, by at least one transceiver, to the second non-transitory computer readable medium to join the electronic social media network from the first non-transitory computer readable medium.

10. The method of claim 1, further comprising limiting an amount of time the second non-transitory computer readable has to complete the disassembled photographic media puzzle by the first non-transitory computer readable medium.

11. A computer implemented method for operating an electronic social media network of an at least one non-transitory computer readable medium and an at least one non-transitory computer readable database comprising:
transmitting, by at least one transceiver, a disassembled photographic media puzzle by the at least one non-transitory computer readable database;
receiving, by at least one transceiver, a disassembled photographic media puzzle by the at least one non-transitory computer readable medium;
storing, by at least one computer processor, the disassembled photographic media puzzle by the at least one non-transitory computer readable medium in a first memory location;
re-assembling, by at least one computer processor through manipulation on a display interface, the disassembled photographic media puzzle into a re-assembled photographic media puzzle by the at least one non-transitory computer readable medium; and
verifying automatically, by at least one computer processor on a puzzle piece by puzzle piece basis, each of the puzzle pieces of the re-assembled photographic media puzzle to the corresponding position of a solution for correctness.

12. The method of claim 11, further comprising storing a plurality of disassembled photographic media puzzles in respective data locations by the at least one non-transitory computer readable database.

13. The method of claim 11, further comprising partitioning the disassembled photographic media puzzle into a matrix of uniform pieces.

14. The method of claim 11, further comprising partitioning the disassembled photographic media puzzle into a plurality of non-uniform pieces.

15. The method of claim 11, further comprising limiting an amount of time the at least one non-transitory computer readable medium has to re-assemble the disassembled photographic media puzzle.

16. The method of claim 11, further comprising recording an amount of time the at least one non-transitory computer readable medium has taken to re-assemble the disassembled photographic media puzzle.

17. The method of claim 11, further comprising recording an amount of time the at least one non-transitory computer readable medium has taken to re-assemble the disassembled photographic media puzzle on a leaderboard of the electronic social media network.

18. A non-transitory computer-readable medium having embedded therein a set of instructions that, when executed by one or more processors, causes the non-transitory computer readable medium to execute the following operations:
taking an electronic photograph by an electronic photography device and a camera lens;
storing an electronic photograph in a memory location by a non-transitory computer readable medium;
creating, by at least one computer processor through manipulation on a first display interface, a disassembled photographic media puzzle;
transmitting, by at least one transceiver, the disassembled photographic media puzzle;
receiving, by at least one transceiver, the disassembled photographic media puzzle;
storing, the disassembled photographic media puzzle, in a second memory location on the second non-transitory computer readable medium;
re-assembling, by at least one computer processor through manipulation on a second display interface, the disassembled photographic media puzzle into a re-assembled photographic media puzzle; and
verifying automatically, by at least one computer processor on a puzzle piece by puzzle piece basis, each of the puzzle pieces of the re-assembled photographic media puzzle to the corresponding position of a solution for correctness.
